(19) United States
(12) Patent Application Publication
(10) Pub. No.: US 2005/0207390 A1
(43) Pub. Date: Sep. 22, 2005

(54) Method and system for sending text-based communications to a network access device for an application with video or audio output

(76) Inventors: Ramin Soheili, San Francisco, CA (US); Mahdi Akbar, Sharjah (IR)

Correspondence Address: MAYER, BROWN, ROWE & MAW LLP, P.O. BOX 2828, CHICAGO, IL, 60690-2828, US

(21) Appl. No.: 10/801,398

(22) Filed: Mar. 16, 2004

(51) Int. Cl. H04L 12/56

(52) U.S. Cl. 370/349

(57) ABSTRACT

A method and system for providing communications to a network access device. The network access device has a processor, a memory, and an output. The memory stores application code. An application specific message has a network header and message content. The message content includes an application header and application content. The application specific message is sent to the network access device as a text message over a channel of a communications network. The network access device is capable of identifying the application specific message as a text-based message, as indicated by the network header. The network access device detects the application header of the application specific message, and selects the application as associated with the application specific message. The application content of the application specific message is then provided to the application. The application interprets the application content to generate output data, and the output data is provided on the output of the network access device.

### FIELD

The present invention relates generally to sending messages to devices in communication with a network by wired or wireless communications means. More particularly, the present invention relates to sending text-based messages over a network for processing by network access devices.

### BACKGROUND

The popularity of network access devices such as mobile phones, personal digital assistants (PDAs), and wireless email devices (e.g., Blackberry) has grown tremendously. For people on the move, these network access devices are an invaluable asset, and have become an essential tool in their day-to-day lives. Many people use their network access devices to make calls, check voice messages, send emails, check calendars, and schedule appointments, throughout the day.

The trend with mobile phones, PDAs, wireless email devices, portable games, and other network access devices, is to integrate the functions of these various devices. For example, mobile phones are now constructed to provide various functions in addition to wireless calling. A single mobile phone, such as the SCH-a530, available from Samsung Electronics America, provides internet access, email access, text messaging, calendar functions, and other services. Current mobile phone models also have full color digital displays, and audio outputs to play digital audio files.

While the hardware of conventional network access devices has become more sophisticated, the full capabilities of these devices have not been realized. The software in many conventional network access devices has not supported device-to-device communications in any other way than the transmission of audio data for carrying on a conversation, or the sending of alphanumeric text messages for display on the network access device. Further, there are few, if any, software applications made specifically for network access devices that are capable of receiving, processing, and outputting video and audio data in a meaningful way.

### SUMMARY

Aspects of the present invention relate to a method and system for providing communications to a network access device. The communications are provided over a communications network having a channel supporting text messages. The network access device has a processor, a memory, and an output. The memory stores application code. The code is executable by the processor. An application specific message has a network header and message content. The message content includes an application header and application content. The application specific message is sent to the network access device as a text message over the channel of the communications network. The network access device receives the application specific message and detects the header of the application specific message. The network access device identifies the application specific message as text-based message, as indicated by the network header. The network access device detects the application header of the application specific message, and selects the application as associated with the application specific message. The application content of the application specific message is provided to the application. The application interprets the application content to generate output data, and the output data is provided on the output of the network access device.

### BRIEF DESCRIPTION OF THE FIGURES

The detailed description below may be better understood with reference to the following figures. The figures illustratively show one or more embodiments of the invention, and are not intended to limit the scope of the claims in any way. The components in the figures are not necessarily to scale, emphasis instead being placed upon clearly illustrating principles of the present invention. In the figures, like reference numerals designate corresponding parts throughout the several views.

FIG. 1 shows a block diagram of a system 100 for sending text-based communications to a network access device, constructed according to one embodiment of the present invention;

FIG. 2 shows a block diagram of components of a network access device 200, constructed in accordance with embodiments of the present invention;

FIG. 3 shows a block diagram of a text-based message 300 sent to a network access device over a network, in accordance with one embodiment of the present invention;

FIG. 4 shows a flow diagram of a method 400 for sending text-based communications to a network access device for an application with video and/or audio output, performed in accordance with one embodiment of the present invention;

FIG. 5A shows a network access device having a display on which a graphical user interface 500A is generated, in accordance with one embodiment of the present invention;

FIG. 5B shows a network access device having a display on which a graphical user interface 500B is generated, in accordance with one embodiment of the present invention;

FIG. 5C shows a network access device having a display on which a graphical user interface 500C is generated, in accordance with one embodiment of the present invention; and

FIG. 6 shows a network access device having a display on which a graphical user interface 600 is generated, in accordance with yet another embodiment of the present invention.

### DETAILED DESCRIPTION

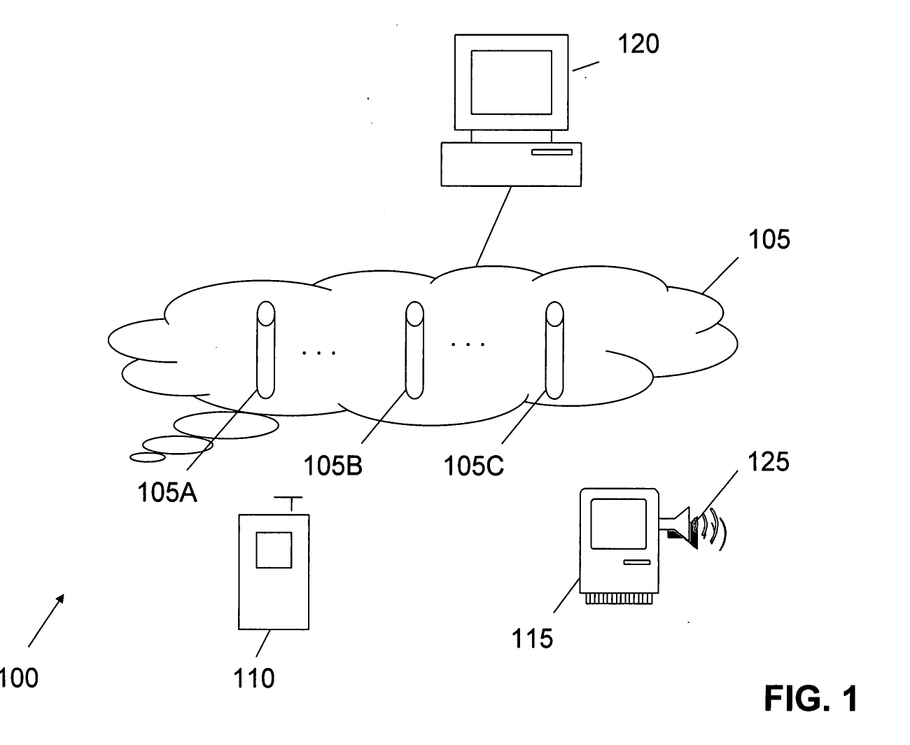

FIG. 1 shows a system 100 for sending text-based communications to a network access device, constructed according to one embodiment of the present invention. In FIG. 1, a communications network 105, also referred to herein as a “network” or “data network,” is shown. Various communication services and networks, and combinations thereof, can serve as network 105. These include conventional telephone networks, wireless networks such as cellular and paging service networks, and other networks with messaging service capabilities. Examples of suitable cellular and paging networks include services such as Pageant, Skytel, and Pagemart. Other suitable paging and messaging services include Personal Communications Systems (PCS), Global System For Mobile (GSM), DCT-1800, DCT-1900, 900 Mhz GSM, and Enhanced Specialized Mobile Radio (EPSMR). Suitable text-based communications networks include Short Message Service (SMS), Enhanced Messaging Service (EMS), and Multimedia Messaging Service (MMS).

In FIG. 1, the communications network 105 includes a plurality of communications channels including channel 105A, channel 105B and channel 105C. Each of the channels 105A-C can have particular functions. For instance, in some networks, channel 105A is a communications channel which passes audio signals or audio data such as voice information for playing on a receiving device such as a mobile phone 110. Channel 105B, in this instance, serves a different function than channel 105A, namely carrying text-based data and messages over the communications network 105B. In other examples, all of the channels 105A-C in communications network 105 are capable of carrying text-based messages between devices and systems. The channels 105A-C in communications network 105 can have various roles, depending on the particular embodiment. Preferably, at least one channel in the network 105 is capable of carrying text data.

In one embodiment, the communications network 105 includes a SMS network, allowing alphanumeric messages to be passed between devices and systems on the network. In this example, channel 105A is a control channel of the SMS network, and channel 105B is a voice or communications channel. The control channel 105A passes textual messages, while the communications channel 105B carries communications signals such as audio data.

In some embodiments, the communications network 105 provides paging services and wireless email services with text messages being passed by one or more of the channels 105A-C. In other embodiments, any binary channel in the communications network 105 can serve as a text-based channel for carrying text messages over the network.

In another embodiment, text messages are passed over channels of communications network 105 that are ordinarily used to carry voice and other audio signals and data. In this configuration, text messages are sent over the communications channel 105B in packets or other configurations so the receiving device can interpret the message as a text message, and can process the message.

FIG. 1 shows a plurality of network access devices 110, 115, and 120 in communication with the network 105. In the embodiment shown in FIG. 1, the network access devices include a mobile phone 110, a personal digital assistant (PDA) 115 with speaker 125, and a desktop computer 120. The mobile phone 110 and PDA 115 are in wireless communication with the network 105, while the desktop computer 120 communicates with the network by conventional wired means. In other embodiments, the network access devices include various apparatus and systems in addition to those shown in FIG. 1. Suitable network access devices include laptop computers, workstations, servers, and other data processing apparatus. These network access devices can be in wired or wireless communication with the network 105.

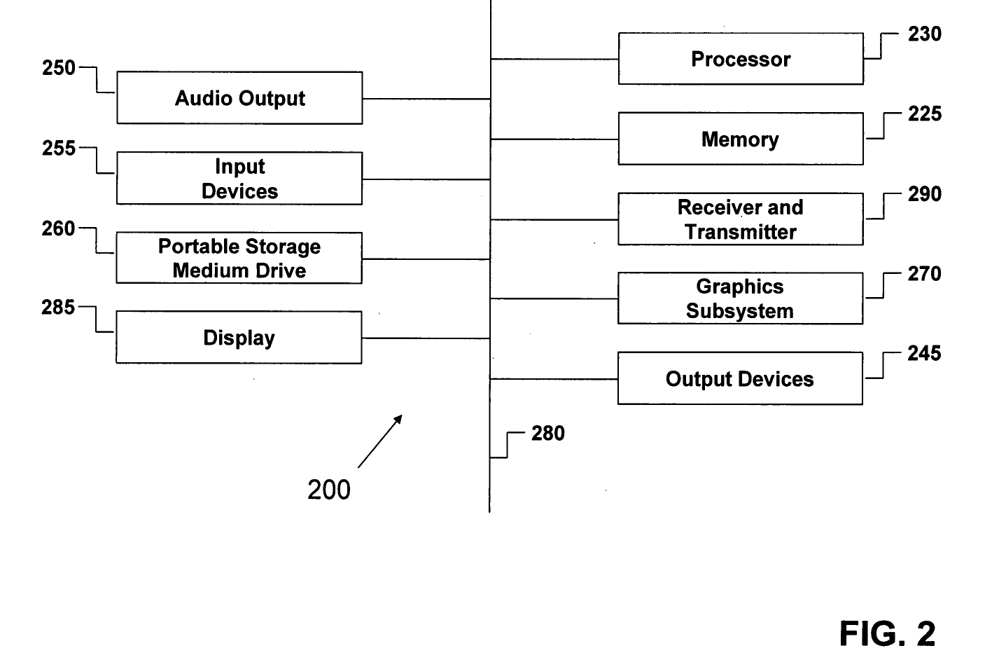

FIG. 2 shows the components of a typical network access device 200 used in accordance with embodiments of the present invention. The network access device 200 of FIG. 2 includes a processor 230 and memory 225. Processor 230 may contain a single microprocessor, or may contain a plurality of microprocessors, for configuring the computer system as a multi-processor system. Memory 225 stores, in part, instructions and data for execution by processor 230. Such instructions and data comprise the code of an application such as a game application, financial application, language or font application, or other application as described below. This code is executable by processor 230. Memory 225 may include banks of dynamic random access memory (DRAM) as well as high speed cache memory.

In FIG. 2, the network access device 200 further includes a receiver and transmitter unit 290 which performs the functions of sending and receiving text-based messages, audio signals, and other data, to and from any of the communications networks described above. The receiver and transmitter unit 290 includes conventional components to provide these functions.

The network access device 200 of FIG. 2 further includes an audio output 250, input devices 255, portable storage medium drive 260, a graphics subsystem 270 and a display 285. For purposes of simplicity, the components shown in FIG. 2 are depicted as being connected via a single bus 280 (i.e. transport means). However, the components may be connected through one or more data transport means. For example, processor 230 and memory 225 may be connected via a local microprocessor bus, and the portable storage medium drive 260, and graphics subsystem 270 may be connected by one or more input/output (I/O) buses.

Portable storage medium drive 260 operates in conjunction with a portable non-volatile storage medium, such as a memory card, or other processor readable storage medium, to input and output data and code to and from the network access device 200. Input device(s) 255 provide a portion of a user interface. Input device(s) 255 may include an alphanumeric keypad for inputting alpha-numeric and other key information, or a pointing device, such as a mouse, a trackball, stylus or cursor direction keys.

In order to display textual and graphical information, the network access device 200 of FIG. 2 includes graphics subsystem 270 and display 285. Display 285 includes a liquid crystal display (LCD) or other suitable display devices, that enables a user to view information. Graphics subsystem 270 receives textual and graphical information and processes the information for output to display 285.

The network access device 200 also includes an audio output 250. In one embodiment, audio output 250 includes a sound amplifier. In another embodiment, the audio system 250 includes a processor, such as processor 230, that processes sound. Additionally, the network access device 200 includes other outputs or output devices 245. Examples of suitable outputs 245 include a speaker, an antenna, and a display output such as display 285.

Several of the components contained in the network access device 200 of FIG. 2 are those typically found in general purpose computer, and are intended to represent a broad category of such computer components that are well known in the art. FIG. 2 illustrates one platform which can be used for practically implementing the method of the present invention. Numerous other platforms can also suffice, such as Macintosh-based platforms available from Apple Computer, Inc., platforms with different bus configurations, networked platforms, multi-processor platforms, other personal computers, laptop computers, workstations, mainframes, navigation systems, and the like.

Examples of applications executed on processor 230 of network access device 200, in accordance with embodiments of the present invention, include games, financial applications, weather applications, medical applications, font and language processing applications, and other various applications which are capable of responding to an incoming text message over a text-based channel, interpreting the data in the text message, and outputting, in response, audio data and/or graphical or video data including still images, and motion picture images such as animation.

In addition to financial data and game related data, text-based messages tailored to applications running on network access devices, in accordance with embodiments of the present invention, can include weather data, medical data, various language font information, other types of video data, animation data, charts, and other images. Other text-based messages include audio data such as music notes. The notes are translated into text data, formatted according to a predetermined protocol, packaged and sent to the network access device 200 over the network 105.

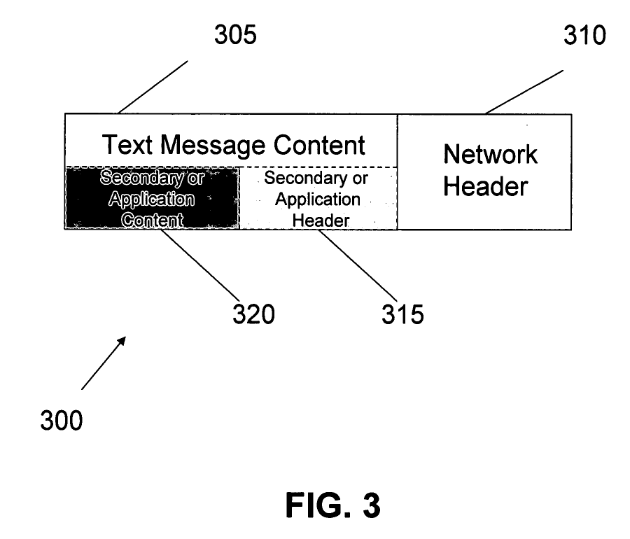

Typically, application specific messages such as gaming messages do not require much bandwidth. Instructions for gaming purposes are generally low in content and can fit into one text message for delivery over a text-supporting channel of the network 105. Applications contents such as Audio, Video and longer text messages may require multiple message transmissions for the entire information to be sent over the channel. In such cases, the data at the sender's network access device is broken into a known number of fixed messages each with an appropriate application header 315, described below with respect to FIG. 3, containing the order of the messages in the sequence. At the receiving network access device, during the decoding of application header 315, the application will await the arrival of other messages in the sequence. Once all messages relating to a single application have been received and verified, the application will strip the application header information off the message and concatenate the application contents to form one complete piece of information for the intended application to decode. In another example, messages longer than a predetermined number of bytes, for instance, 160 bytes, are sent over the control channel 105A using multiple SMS type packets. At the receiving device, each message is treated as a single SMS message and no knowledge or information is provided in helping to reconstruct the one long original message.

FIG. 3 shows a block diagram of a text-based data message 300 sent to a network access device over the network 105. The text message 300 includes header information 310 which identifies the purpose of the received bit stream for the communications network 105, and includes content information 305. The contents 305 of the text-based message are preferably packaged in a format allowing the network access device to distinguish the message from other incoming text data messages. In one embodiment, as shown in FIG. 3, the contents 320 of the text-based message are preceded by a header 315 which signals the network access device receiving the incoming message that the message is intended for processing by any of the applications described above. In other embodiments, the text-based message 300 is packaged in other formats suitable for receipt and processing by the application(s) executing on the network access device.

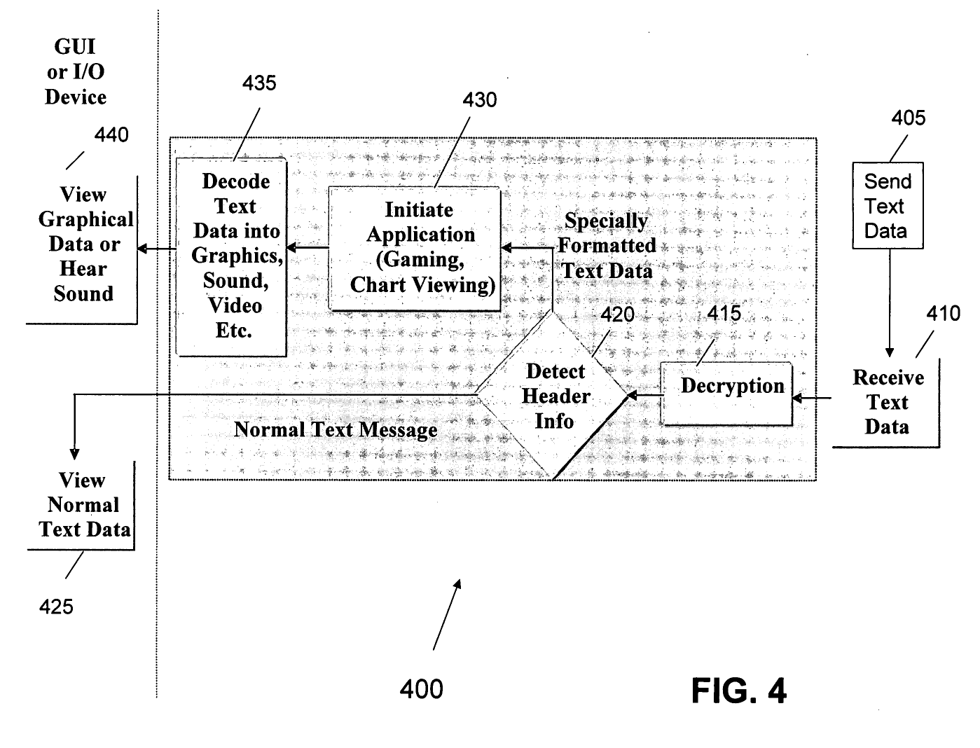

FIG. 4 shows a flow diagram of a method 400 for sending text-based communications to a network access device for an application, performed in accordance with one embodiment of the present invention. FIG. 4 is described with reference to FIGS. 1-3.

In FIG. 4, the method begins in step 405, in which an application specific message is sent to a network access device as a text message over one of the channels 105A-C in the network 105. In one example, a user of a network access device such as mobile phone 110 selects a menu option from a list displayed on the phone 110, selects messaging, inserts a destination phone number or an email address and then types the message. Typically these messages are bound by the data size, which is governed by the infrastructure and wireless protocol design. For instance, a message size of 160 bytes is very common in wireless cellular messaging applications. Upon clicking a Send button on phone 110, the message 300 is then sent over the control channel 105A to a SMSC. The SMSC is a central store and forward facility that accepts, buffers, processes, and distributes SMS messages in a network.

In step 410 of FIG. 4, the text message 300 is received over one of the channels 105A-105C, such as the control data channel, of communications network 105 from the SMSC by a network access device, such as personal digital assistant (PDA) 115 of FIG. 1. When the message 300 is received, the receiving device 115 will detect network header information 310 which indicates the type of message being sent over the network. When the receiving device 115 detects a text messaging service in the header information 310, the device 115 will strip header information 310 from the content information 305.

In embodiments involving encryption and decryption processes, the method proceeds to step 415 in which a decryption operation is performed on a received encrypted text message 300. This decryption operation is described below.

After a message 300 is received and identified in step 410, the contents 305 of the text message can be displayed in ASCII format on the screen for viewing 425. Prior to the displaying in step 425, however, a secondary identification of the message 300 is performed in step 420. In particular, a filtering process 420 will be carried out on the incoming text message to identify if the content portion 305 of the message 300 has a secondary or application header 315, separate and apart from the network header 310, and secondary or application content information 320. If the filtering process in step 420 does not detect such further levels of application header 315 and content information 320, or the header 315 does not indicate that the message 300 is intended for the application executing on the processor of the network access device, then the method proceeds to step 425 in which the message is displayed as text data. If, however, the filtering process 420 does indeed detect application header information 315, then the message 300 is identified as an application specific message, and the method proceeds to step 430.

In step 420 of FIG. 4, the application header information 315 generally includes a known sequence of bitstream pattern. Such a known pattern of bits is also referred to as a sync word. Once the filtering process of step 420 identifies this sync word, the message will be treated differently than an ordinary text message. In other embodiments, intuitive techniques such as looking at bits in the application header information 315 and detecting the application type and matching the application content information 320 to that of the application header 315 can provide further confidence in the filtering decision. For example, if the filtering process of step 420 detects a known sync word and it then further detects that the application is that of a game of chess and it further detects that move information in the application content information 320 reads KA9, then it can intuitively reject this as a special formatted message since no square of position A9 exists nor is allowed in a game of chess.

In FIG. 4, once the filtering process of step 420 determines that content 305 is an application specific message, that is, includes a formatted binary data stream, an application detection program is initiated by following a set of rules to match the secondary header information 315 with the application. In step 430, an initiate application module will analyze the secondary header information 315 and, based on this information, initiate the application appropriate for digesting the content information 320.

Once the appropriate application is selected, in step 430, a new format of display is sent to the display 285 for viewing, in step 435. The new format with a user-friendly interface will then provide options for the user to decide on the actions to be taken, in step 440. For example, if the secondary content 320 is of an audio nature then an audio playing application, in step 440, will ask the user to select features such as play, stop, slow, and pause.

In FIG. 3, the format of the secondary or application header 315 can be a simple sequential set of binary data bits. In one example, a sequence of 2 bits of 11 in the most significant location of the bit stream indicates that the application data or content 320 is of a video nature. This will then be followed by another bit indicating whether more application data are expected following the current message. Such a feature can again be implemented using a 1-bit flag adjacent to the leading two bits. In this example, because the two leading bits indicate a video application, a video viewing graphic display interface will be executed the screen display. Upon a command to play by the user, the application will then decode, in step 435, the application contents 320, and continue to display the decoded information until all the data in the text message data is decoded.

Some embodiments of the present invention provide secure messaging methods and systems. In such cases an encryption/decryption algorithm known to both the sending and receiving devices is integrated into the application decoding software. In one example, a user wishes to have a secure messaging service. Upon entering the text message, he chooses to have it encrypted for a secure transmission. The text message is then padded with the appropriate text messaging header information and then sent to an Encryption unit. Preferably, the output of the encryption unit will be the same size as the input bitstream. A simple Encryption method may compromise of a password and username design methodology that is known to both the sender and the receiving party.

Once the encrypted message is received it will be viewed as a string of binary format data. In step 415 of FIG. 4, the received encrypted message will then be put through a decryption unit that attempts in deciphering the application data. The receiving party may need to input a username and password to ensure that a correct deciphering method has taken place. If a failure occurs the user may be prompted to enter again until a known number of failures have reached.

If the decryption process is successful then the resulting output of the decryption unit, in step 415, will have unique application header information 315 that will be acceptable to the application initiation software in step 430. Otherwise, the data will be treated as an ordinary text message and displayed as ASCII text.

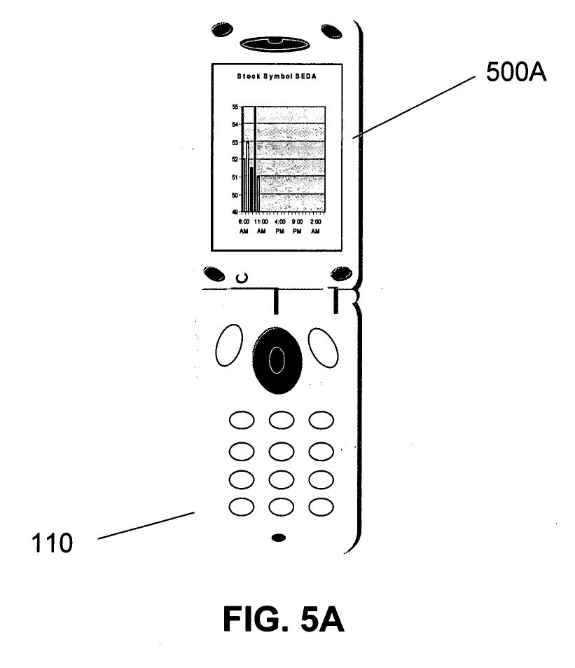

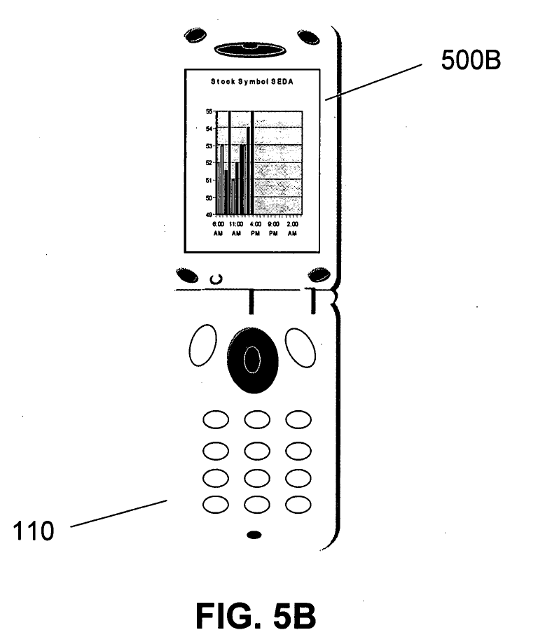

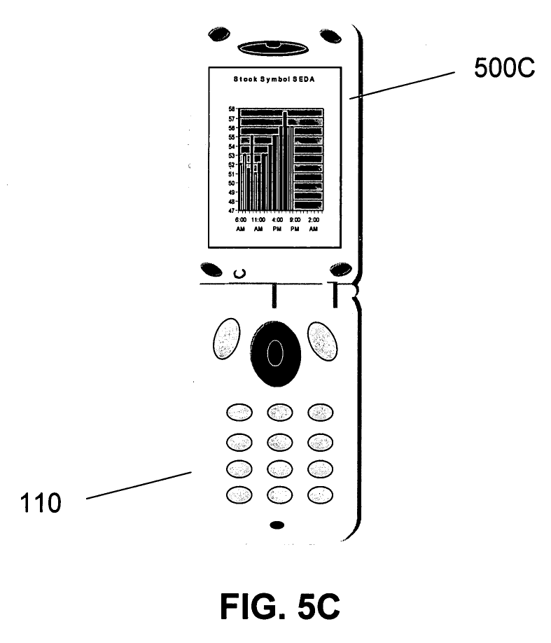

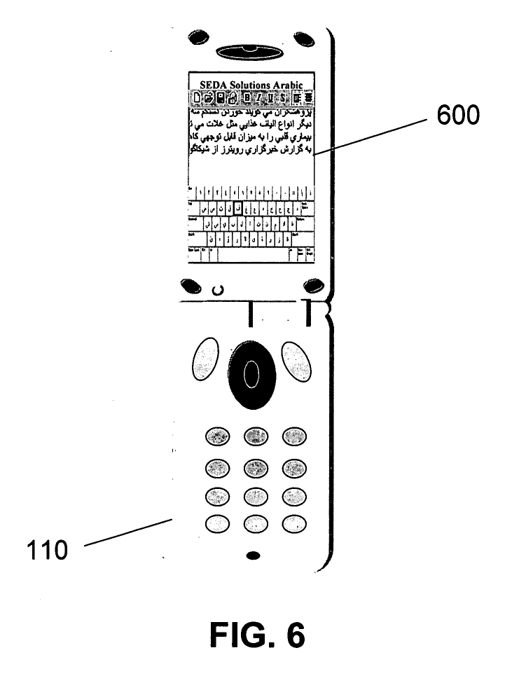

In steps 435 and 440 of FIG. 4, when the decoded text data results in video output data for display, this often results in the updating of an existing image displayed on the network access device. In other instances, an initial image is generated for display on the network access device. Various displays are contemplated. Examples of graphical user interfaces for these displays are shown in FIGS. 5A-5C, and FIG. 6, and described below.

In another embodiment, when the interpreted text data in step 435 of FIG. 4 results in audio data, the audio data is played on a speaker 125 of network access device 115. Such audio data may include music MIDI files, .wav files, and other audio files in formats recognizable by the network access devices described above.

### EXAMPLES

In one example of a financial application, described with reference to FIGS. 1 and 5A-C, a server 120 provides stock data on a regular basis. A user, operating PDA 115, receives this stock data in the form of text messages 300 on an hourly basis or other time interval for graphical viewing on the display of PDA 115. In this example, messages 300 are sent over the control channel of an SMS network from the server 120 to the PDA 115. The secondary or application header 315 in message 300 indicates to a financial application executing on PDA 115 that the secondary or application content 320 included in the message 300 is intended for processing by the financial application. The application receives the application content 320, and updates a graphical representation of stock data shown on the display of PDA 115. FIGS. 5A-5C, show the graphical display and output of three messages 300 received in fixed intervals for the stock symbol “SEDA.” In this example, each message contains five pricing data points, and each message is sent from a server every 60 minutes. The contents of each message are added to the contents of any previous message(s) before being displayed.

FIG. 6 shows an example of graphical user interface 600 generated for display on a network access device, in accordance with yet another embodiment of the present invention. In FIG. 6, the displayed video data is for an application which allows the editing of a non-English font which can be sent to another device for viewing by the same application software and without the need for the network access device itself to support non-English fonts.

It should be emphasized that the above-described embodiments of the invention provide examples for a clear understanding of the principles of the invention. Variations and modifications can be made to the above-described embodiments without departing from the spirit and principles of the invention, as will be understood to those skilled in the art. All such modifications and variations are intended to be included within the scope of the invention and protected by the following claims.

1. A method for providing communications to a network access device over a communications network having a channel supporting text messages, the method comprising the steps of:
providing a network access device, the network access device having a processor, a memory, and an output, the memory storing code of an application, the code executable by the processor, the network access device in communication with the communications network;
providing an application specific message having a network header and message content, the message content including an application header and application content, the network header identifying the application specific message as a text-based message;
sending the application specific message to the network access device as a text message over the channel of the communications network;
receiving, by the network access device, the application specific message;
detecting, by the network access device, the network header of the application specific message;
identifying, by the network access device, the application specific message as a text-based message, as indicated by the network header;
detecting, by the network access device, the application header of the application specific message;
selecting, by the network access device, the application as associated with the application specific message;
providing the application content of the application specific message to the application;
interpreting, by the application, the application content of the application specific message to generate output data; and
providing, on the output of the network access device, the output data.

2. The method of claim 1, the application header of the application specific message including a sync word.

3. The method of claim 2, the step of selecting the application as associated with the application specific message including interpreting the sync word.

4. The method of claim 2, the sync word including a predetermined sequence of bits.

5. The method of claim 1, wherein the network access device is a mobile phone.

6. The method of claim 1, wherein the network access device is a personal digital assistant (PDA).

7. The method of claim 1, wherein the application is a game.

8. The method of claim 7, wherein the message content in the application specific message includes game data.

9. The method of claim 1, wherein the application is a financial application.

10. The method of claim 9, wherein the message content in the application specific message includes financial data.

11. The method of claim 1, wherein the application is a language translation program.

12. The method of claim 11, wherein the message content in the application specific message includes font data.

13. The method of claim 1, wherein the application specific message includes weather data.

14. The method of claim 1, wherein the application specific message includes medical data.

15. The method of claim 1, wherein the communications network includes a short message service (SMS) network.

16. The method of claim 15, wherein the application specific message is a short message service (SMS) message.

17. The method of claim 1, wherein the output data includes video data.

18. The method of claim 17, wherein the output includes a display.

19. The method of claim 1, wherein the output data includes audio data.

20. The method of claim 19, wherein the output includes a sound processor.

21. The method of claim 1, wherein the communications network includes a paging service.

22. The method of claim 1, wherein the communications network includes a wireless email service.

23. The method of claim 1, wherein the communications network includes an enhanced messaging service (EMS).

24. The method of claim 1, wherein the communications network includes a multimedia messaging service (MMS).

25. A method for providing communications to a network access device over a communications network having a channel supporting text messages, the method comprising the steps of:
providing a network access device, the network access device having a processor, a memory, and an output, the memory storing code of an application, the code executable by the processor, the network access device in communication with the communications network;
providing an application specific message having a network header and message content, the message content including an application header and application content, the network header identifying the application specific message as a text-based message;
encrypting the application specific message to produce an encrypted application specific message;
sending the encrypted application specific message to the network access device as a text message over the channel of the communications network;
decrypting the encrypted application specific message, by the network access device, to produce the application specific message;
detecting, by the network access device, the network header of the application specific message;
identifying, by the network access device, the application specific message as a text-based message, as indicated by the network header;
detecting, by the network access device, the application header of the application specific message;
selecting, by the network access device, the application as associated with the application specific message;
providing the application content of the application specific message to the application;
interpreting, by the application, the application content of the application specific message to generate output data; and
providing, on the output of the network access device, the output data.

26. The method of claim 25, wherein the step of decrypting the encrypted application specific message includes providing a user ID and a password.

27. An interactive communications system using a communications network having a channel supporting text messages, the system comprising:
a first network access device, the first network access device having a processor, a memory, and an output, the memory storing code of an application, the code executable by the processor, the first network access device in communication with the communications network;
a second network access device, the second network access device having a processor and a memory, the memory storing an application specific message having a network header and message content, the message content including an application header and application content, the network header identifying the application specific message as a text-based message, the second network access device in communication with the communications network;
the second network access device configured to send the application specific message to the first network access device as a text message over the channel of the communications network;
the first network access device configured to:
(i) receive the application specific message,
(ii) detect the network header of the application specific message,
(iii) identify the application specific message as a text-based message, as indicated by the network header,
(iv) detect the application header of the application specific message,
(v) select the application as associated with the application specific message,
(vi) provide the application content of the application specific message to the application,
(vii) interpret, by the application, the application content of the application specific message to generate output data, and
(viii) provide, on the output of the network access device, the output data.

28. The system of claim 27, wherein the first network access device is a mobile phone.

29. The system of claim 28, wherein the second network access device is a mobile phone.

30. The system of claim 27, wherein the first network access device is a personal digital assistant (PDA).

31. The system of claim 27, wherein the communications network includes a short message service (SMS).

32. The system of claim 31 wherein the application specific message is a short message service (SMS) message.

33. The system of claim 27, wherein the communications network includes a paging service.

34. The system of claim 27, wherein the communications network includes a wireless email service.

35. The system of claim 27, wherein the communications network includes an enhanced messaging service (EMS).

36. The system of claim 27, wherein the communications network includes a multimedia messaging service (MMS).

37. A processor readable storage medium having processor readable code for programming one or more processors in a network access device to perform a method for receiving communications over a communications network having a channel supporting text messages, the network access device in communication with the communications network, the network access device having a processor, a memory and an output, the memory storing application code of an application, the application code executable by the one or more processors, the method comprising the steps of:
receiving an application specific message as a text message over the channel of the communications network, the application specific message having a network header and message content, the message content including an application header and application content, the network header identifying the application specific message as a text-based message;
detecting, by the network access device, the network header of the application specific message;
identifying, by the network access device, the application specific message as a text-based message, as indicated by the network header;
detecting, by the network access device, the application header of the application specific message;
selecting, by the network access device, the application as associated with the application specific message;
providing the application content of the application specific message to the application;
interpreting, by the application, the application content of the application specific message to generate output data; and
providing, on the output of the network access device, the output data.

38. The processor readable storage medium of claim 37, wherein the message content in the application specific message includes music data.

39. The processor readable storage medium of claim 37, wherein the message content in the application specific message includes voice data.

40. The processor readable storage medium of claim 37, wherein the application is a language translation program.

41. The processor readable storage medium of claim 41, wherein the application specific message includes font data.

42. The processor readable storage medium of claim 37, wherein the application is a financial application.

43. The processor readable storage medium of claim 42, wherein the application specific message includes financial data.

44. The processor readable storage medium of claim 37, wherein the application specific message includes weather data.

45. The processor readable storage medium of claim 37, wherein the application specific message includes medical data.
